(19) United States
(12) Patent Application Publication
(10) Pub. No.: US 2011/0261038 A1
(43) Pub. Date: Oct. 27, 2011

(54) ELECTRONIC DEVICE AND METHOD OF ADJUSTING VIEWING ANGLES OF LIQUID CRYSTAL DISPLAYS

(75) Inventors: WEI JIANG, Shenzhen City (CN); XIAO-GUANG YU, Shenzhen City (CN); FAN REN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/884,209

(22) Filed: Sep. 17, 2010

(30) Foreign Application Priority Data
Apr. 26, 2010 (CN) 201010155749.5

(51) Int. Cl. G09G 5/00; G06K 9/46; G09G 3/36; G02F 1/1335

(52) U.S. Cl. 345/207; 349/17; 382/195; 345/87

(57) ABSTRACT

In an electronic device and a method of adjusting a viewing angle of a liquid crystal display (LCD), a face recognition reference is established. The face recognition reference is compared with faces in an image which is captured by a camera unit to locate a matched face. An adjusted viewing angle of the LCD is computed according to a default viewing angle of the LCD and an angle between a perpendicular of the LCD and a line formed by connecting a center of the LCD and a center of two eyes in the matched face. A voltage value is computed according to the adjusted viewing angle, and a voltage is applied to the liquid crystal molecules of the LCD according to the voltage value to change the default viewing angle of the LCD to the adjusted viewing angle.

### BACKGROUND

1. Technical Field

Embodiments of the present disclosure generally relate to information security technique, and more particularly to an electronic device and a method of adjusting a viewing angle of a liquid crystal display (LCD) of the electronic device, to prevent unwanted viewing of information shown on the LCD.

2. Description of Related Art

It is well known that, a liquid crystal display (LCD) has a viewing angle. In display technology parlance, the viewing angle is the maximum angle at which a display can be viewed with acceptable visual performance.

If the viewing angle of a LCD is too narrow, viewers who aren't directly in front of the LCD won't see high-quality images shown on the LCD. Those viewers who are on the sides of the LCD will see an image that is dull, less contrast, and with colors that may even appear altered. On the contrary, if the viewing angle of a LCD is too wide, information security may be a problem. For example, if a user is checking the balance of his/her bank account using an automated teller machine (ATM) employing a LCD that has a wide viewing angle, somebody else who is located next to the user of the ATM may clearly see information shown on the LCD of the ATM. For another example, if the LCD of a mobile phone has a wide viewing angle and when the owner of the mobile phone edits a message using the mobile phone, someone else may easily view the message.

### BRIEF DESCRIPTION OF THE DRAWINGS

FIG. 1 is a block diagram of an electronic device, according to some embodiments of the present disclosure.

FIG. 2 is a block diagram illustrating function modules of a viewing angle adjusting system included in the electronic device of FIG. 1, according to some embodiments of the present disclosure.

FIG. 3 is a flowchart of a method of establishing a face recognition reference, according to some embodiments of the present disclosure.

FIG. 4 is a flowchart of a method of adjusting viewing angles of liquid crystal displays (LCD) of the electronic device of FIG. 1, according to some embodiments of the present disclosure.

FIGS. 5A-5B illustrates two different viewing angles of the LCD.

### DETAILED DESCRIPTION

The application, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may be comprised of connected logic units, such as gates and flip-flops, and may be comprised of programmable units, such as programmable gate arrays or processors. The modules described herein may be implemented as either software and/or hardware modules and may be stored in any type of computer-readable medium or other computer storage device.

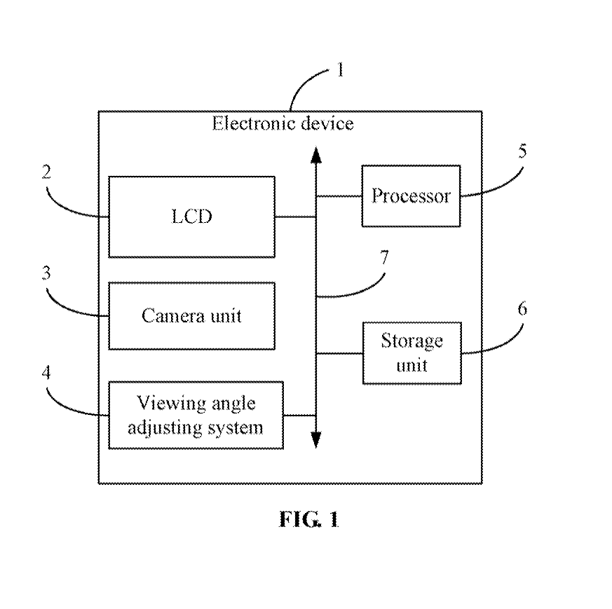

FIG. 1 is a block diagram of an electronic device 1, according to some embodiments of the present disclosure. The electronic device 1 includes components of a liquid crystal display (LCD) 2, a camera unit 3, a viewing angle adjusting system 4, a processor 5, and a storage unit 6. These components communicate over one or more communication buses or signal lines 7. The electronic device 1 can be any electronic device, including but not limited to a computer, a TV set, a mobile phone, a media player, a personal digital assistant (PDA), for example. It should be appreciated that the electronic device 1 may have more or fewer components than shown in FIG. 1, or a different configuration of components. The various components shown in FIG. 1 may be implemented in hardware, software or a combination thereof, including one or more signal processing and/or application specific integrated circuit.

The LCD 2 has a default viewing angle. As described above, the viewing angle is the maximum angle at which a display can be viewed with acceptable visual performance In some embodiments, the default viewing angle is 90°-±δ°. In an example, the default viewing angle may be 75° to 105°. Each pixel of the LCD 2 consists of a layer of liquid crystal molecules aligned between two transparent electrodes, and two polarizing filters, the axes of transmission of which are perpendicular to each other.

The camera unit 3 may be built into the electronic device 1 or may be externally connected to the electronic device 1. In some embodiments, the camera unit 3 is secured at the front of the electronic device 1, to capture images of people located at front of the electronic device 1.

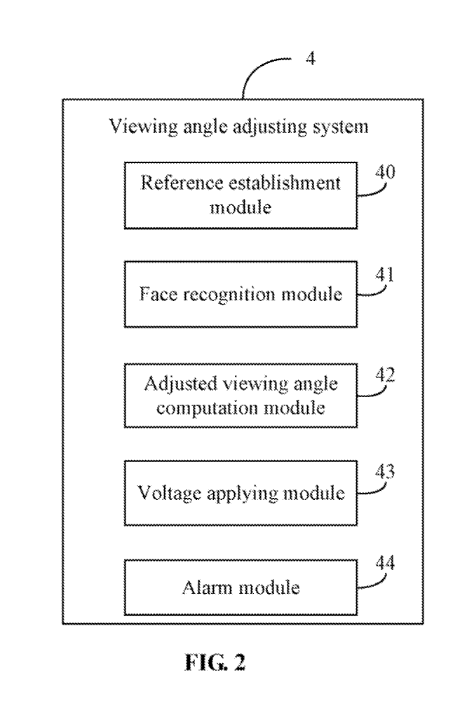

The viewing angle adjusting system 4 includes a plurality of function modules (see below descriptions referring to FIG. 2), to automatically adjust the default viewing angle of the LCD 2, or blacken the screen of the LCD 2, according to face recognition references pre-established and stored in the storage unit 6 and an image just captured by the camera unit 3.

The function modules of the viewing angle adjusting system 4 may be comprised of one or more computerized codes in the form of one or more programs that are stored in the storage unit 6. The storage unit 6 may include high speed random access memory and may also include non-volatile memory, such as one or more magnetic disk storage devices, flash memory devices, or other non-volatile solid state memory devices. The one or more computerized codes of the adjusting system 4 includes instructions that are executed by the processor 5, to provide functions for the function modules of the viewing angle adjusting system 4.

FIG. 2 is a block diagram illustrating function modules of the viewing angle adjusting system 4, according to some embodiments of the present disclosure. The function modules of the viewing angle adjusting system 4 may include a reference establishment module 40, a face recognition module 41, a viewing angle adjusting module 42, a voltage applying module 43, and an alarm module 44.

The reference establishment module 40 establishes a face recognition reference by selecting a face from a reference image which contains at least one face, and stores the face recognition reference into the storage unit 6. It may be appreciated that a selected face is the face recognition reference. The reference image may be originally stored in the storage unit 6 or may be just captured by the camera unit 3. In some embodiments, the reference establishment module 40 may establish more than one face recognition reference.

The face recognition module 41 compares faces in a current image which is just captured by the camera unit 3 with the face recognition reference to determine whether there is a face in the current image matching the face recognition reference, and locates a matched face. In some embodiments, the degree of match between the matched face and the face recognition reference may be greater than a predetermined percent, such as 80 percent.

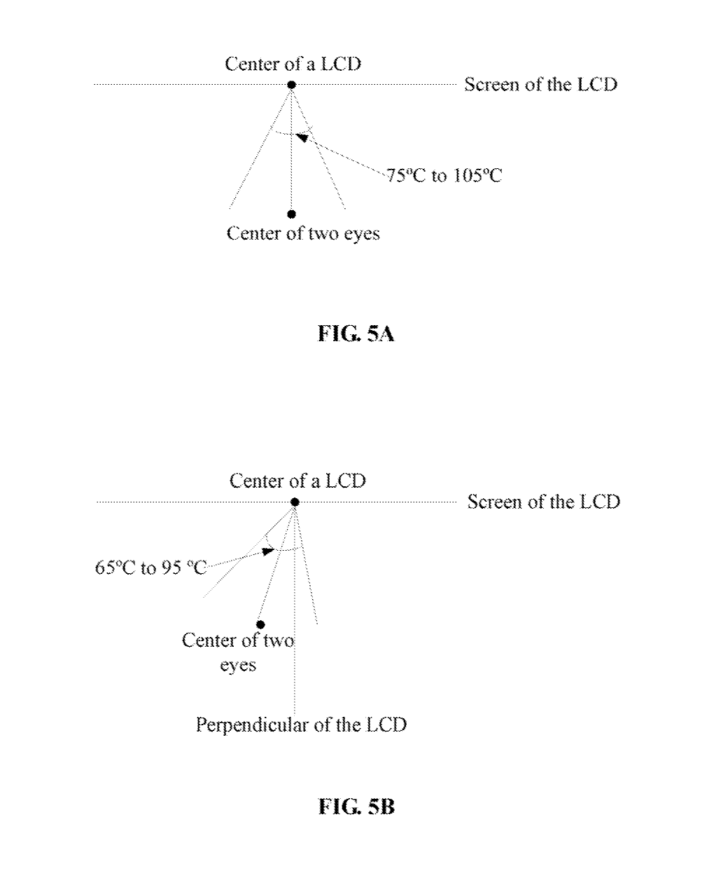

The adjusted viewing angle computation module 42 computes an adjusted viewing angle of the LCD 2 according to the default viewing angle and an angle which is between a perpendicular of the LCD 2 and a line, where the line is formed by connecting a center of the LCD 2 and a center of two eyes in the matched face. In an example, the default viewing angle of the LCD 2, referring to FIG. 5A, is 75° to 105°. Referring to FIG. 5B, the angle, which is between a perpendicular of the LCD 2 and a line formed by connecting the center of the LCD 2 and the center of the two eyes in the matched face, is 10°. Thus, the adjusted viewing angle of the LCD 2 is 65° to 95°.

The voltage applying module 43 computes a voltage value according to the adjusted viewing angle of the LCD 2, and applies a voltage to the liquid crystal molecules of the LCD 2 according to the voltage value. It may be understood that, the liquid crystal molecules of the LCD 2 rearrange themselves when the voltage is applied. Subsequently, the default viewing angle of the LCD 2 is adjusted after the liquid crystal molecules of the LCD 2 rearrange themselves.

The alarm module 44 blackens the screen of the LCD 2 and gives an alarm if there is no face in the current image matching the face recognition reference.

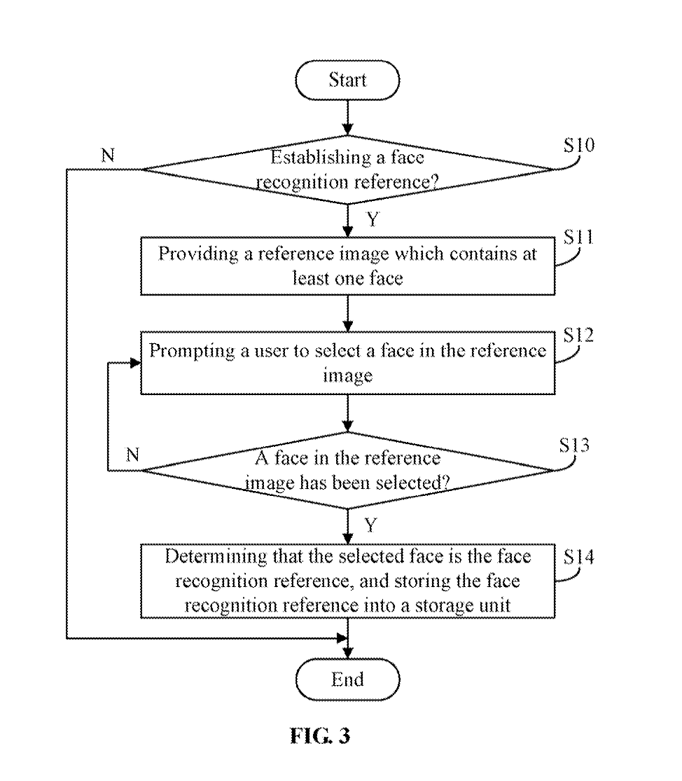

FIG. 3 is a flowchart of a method of establishing a face recognition reference, according to some embodiments of the present disclosure. The method being performed by execution of computer readable program code by the processor 5 of the electronic device 1.

In block S10, the reference establishment module 40 determines whether to establish a face recognition reference. In some embodiments, there may be a dialog box on the screen of the LCD 2 of the electronic device 1, to request information of whether to establish a face recognition reference from a user. If the user does not want to establish a face recognition reference, the user dismisses the dialog box with “cancel”, then, the flow ends. Otherwise, if the user wants to establish a face recognition reference, the user dismisses the dialog box with “okay”, then, block S11 is implemented.

In block S11, the reference establishment module 40 provides a reference image that contains at least one image. The reference image may be originally stored in the storage unit 6 or may be just captured by the camera unit 3.

In block S12, the reference establishment module 40 prompts the user to select a face in the reference image, and in block S13, the reference establishment module 40 determine if a face in the reference image has been selected. Block S14 is implemented if a face in the reference image has been selected. Otherwise, block S12 is repeated if no face in the reference image has been selected.

In block S14, the reference establishment module 40 determines that a selected face is the face recognition reference, and stores the face recognition reference into the storage unit 6.

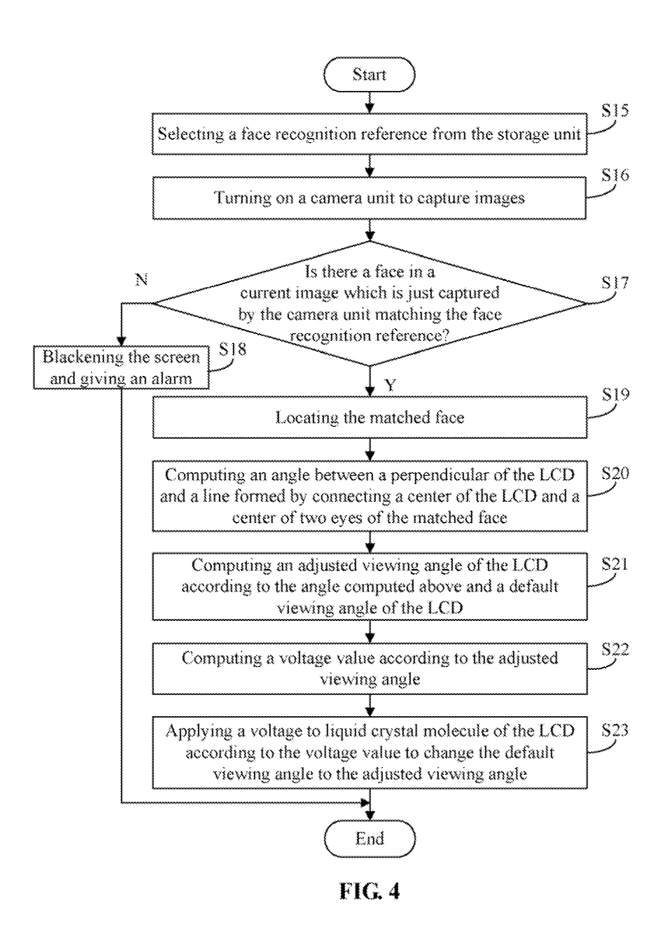

FIG. 4 is a flowchart of a method of adjusting a viewing angle of a liquid crystal display, according to some embodiments of the present disclosure. The method being performed by execution of computer readable program code by the processor 5 of the electronic device 1.

In block S15, the user selects a face recognition reference from the storage unit 6, and in block S16, the camera unit 3 of the electronic device 1 is automatically turned on.

In block S17, the face recognition module 41 compares faces in a current image which is just captured by the camera unit 3 with the face recognition reference, to determine whether there is a face in the current image matching the face recognition reference. Block S18 is implemented if there is no face in the current image matching the face recognition reference. Otherwise, block S19 is implemented if there is a face in the current image matching the face recognition reference.

In block S18, the alarm module 44 blackens the screen of the LCD 2 and gives an alarm, then the procedure ends. In block S19, the face recognition module 41 locates a matched face. In some embodiments, the degree of match between the matched face and the face recognition reference may be greater than a predetermined percent, such 80 percent.

In block S20, the adjusted viewing angle computation module 42 computes an angle, which is between a perpendicular of the LCD 2 and a line formed by connecting a center of the LCD 2 and a center of two eyes in the matched face.

In block S21, the adjusted viewing angle computation module 42 computes an adjusted viewing angle of the LCD 2 according to the default viewing angle and the angle computed above. In an example, the default viewing angle of the LCD 2, referring to FIG. 5A, is 75° to 105°. Referring to FIG. 5B, the angle, which is between a perpendicular of the LCD 2 and a line formed by connecting the center of the LCD 2 and the center of the two eyes in the matched face, is 10° C. Thus, the adjusted viewing angle of the LCD 2 is 65° to 95°.

In block S22, the voltage applying module 43 computes a voltage value according to the adjusted viewing angle, and in block S23, the voltage applying module 43 applies a voltage to the liquid crystal molecules of the LCD 2 according to the voltage value, to change the default viewing angle of the LCD 2 to the adjusted viewing angle.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method of adjusting a viewing angle of a liquid crystal display (LCD) of an electronic device, comprising:
(a) selecting a face recognition reference from a storage unit, and turning on a camera unit of the electronic device;
(b) comparing faces in a current image which is captured by the camera unit with the face recognition reference, to determine that whether there is a face in the current image matching the face recognition reference;
(c) locating a matched face;
(d) computing an angle between a perpendicular of the LCD and a line formed by connecting a center of the LCD and a center of two eyes in the matched face;
(e) computing an adjusted viewing angle of the LCD according to a default viewing angle of the LCD and the angle computed above;
(f) computing a voltage value according to the adjusted viewing angle; and
(g) applying a voltage to the liquid crystal molecules of the LCD according to the voltage value, to change the default viewing angle of the LCD to the adjusted viewing angle.

2. The method as described in claim 1, further comprising:
(h) blackening the screen of the LCD and giving an alarm upon condition that there is no face in the current image matching the face recognition reference.

3. The method as described in claim 1, wherein a degree of match between the matched face and the face recognition reference is greater than a predetermined percent.

4. The method as described in claim 1, before (a), further comprising:
providing a reference image which contains at least one image;
prompting the user to select a face in the reference image; and
determining that a selected face is a face recognition reference, and storing the dace recognition reference into the storage unit.

5. The method as described in claim 4, wherein the reference image is originally stored in the storage unit or is captured by the camera unit.

6. A non-transitory storage medium having stored thereon instructions that, when executed by a processor, cause the processor to perform a method of adjusting a viewing angle of a liquid crystal display (LCD) in an electronic device, comprising:
(a) selecting a face recognition reference from a storage unit, and turning on a camera unit of the electronic device;
(b) comparing faces in a current image which is captured by the camera unit with the face recognition reference, to determine that whether there is a face in the current image matching the face recognition reference;
(c) locating a matched face;
(d) computing an angle between a perpendicular of the LCD and a line formed by connecting a center of the LCD and a center of two eyes in the matched face;
(e) computing an adjusted viewing angle of the LCD according to a default viewing angle of the LCD and the angle computed above;
(f) computing a voltage value according to the adjusted viewing angle; and
(g) applying a voltage to the liquid crystal molecules of the LCD according to the voltage value, to change the default viewing angle of the LCD to the adjusted viewing angle.

7. The non-transitory storage medium as described in claim 6, wherein the method further comprises:
(h) blackening the screen of the LCD and giving an alarm upon condition that there is no face in the current image matching the face recognition reference.

8. The non-transitory storage medium as described in claim 6, wherein a degree of match between the matched face and the face recognition reference is greater than a predetermined percent.

9. The non-transitory storage medium as described in claim 6, wherein before (a), the method further comprises:
providing a reference image which contains at least one image;
prompting the user to select a face in the reference image; and
determining that a selected face is a face recognition reference, and storing the dace recognition reference into the storage unit.

10. The non-transitory storage medium as described in claim 9, wherein the reference image is originally stored in the storage unit or is just captured by the camera unit.

11. A electronic device, comprising:
a liquid crystal display (LCD);
a camera unit;
at least one processor;
storage unit;
one or more programs that are stored in the storage unit and are executed by the at least one processor, the one or more programs comprising:
a reference establishment module to establish a face recognition reference;
a face recognition module to compare faces in a current image which is captured by the camera unit with the face recognition reference , to determine that whether there is a face in the current image matching the face recognition reference, and to locate a matched face;
an adjusted viewing angle computation module to compute an adjusted viewing angle of the LCD according to a default viewing angle of the LCD and an angle between a perpendicular of the LCD and a line formed by connecting a center of the LCD and a center of two eyes in the matched face; and
a voltage applying module to compute a voltage value according to the adjusted viewing angle of the LCD, and apply a voltage to the liquid crystal molecules of the LCD according to the voltage value to change the default viewing angle of the LCD to the adjusted viewing angle.

12. The electronic device as described in claim 11, wherein the reference establishment module further to store the face recognition reference into the storage unit.

13. The electronic device as described in claim 11, wherein a degree of match between the matched face and the face recognition reference may be greater than a predetermined percent.

14. The electronic device as described in claim 11, further comprising :
an alarm module to blacken the screen of the LCD and give an alarm if there is no face in the current image matching the face recognition reference.

15. The electronic device as described in claim 11, wherein the camera unit is fixed at the front of the electronic device.

16. The electronic device as described in claim 11, wherein the face recognition reference is established by:
selecting a face from a reference image which contains at least one face as the face recognition reference.

17. The electronic device as described in claim 16, wherein the reference image is originally stored in the storage unit or is captured by the camera unit.
